(19) United States
(12) Patent Application Publication
(10) Pub. No.: US 2024/0217167 A1
(43) Pub. Date: Jul. 4, 2024

(54) ADDITIVE MANUFACTURED PRODUCTS WITH IMPROVED SHEAR STRENGTH

(71) Applicant: Addman Intermediate Holding, LLC, Fort Myers, FL (US)

(72) Inventor: Mark Saberton, Bonita Springs, FL (US)

(73) Assignee: Addman Intermediate Holding, LLC, Fort Myers, FL (US)

(21) Appl. No.: 18/504,685

(22) Filed: Nov. 8, 2023

Related U.S. Application Data
(62) Division of application No. 16/910,556, filed on Jun. 24, 2020, now Pat. No. 11,331,848.
(63) Continuation-in-part of application No. 17/667,081, filed on Feb. 8, 2022, now Pat. No. 11,813,789.
(63) Continuation-in-part of application No. 17/752,985, filed on May 25, 2022.

(51) Int. Cl. B29C 64/112; B29C 64/343; B33Y 10/00

(52) U.S. Cl. CPC B29C 64/112; B29C 64/343; B29K 2995/0078; B29K 2995/0094; B33Y 10/00

(57) ABSTRACT

A 3D manufactured object having improved shear strength by being provided with a stepped bead configuration which alters the fracture angle.

### CROSS-REFERENCE TO RELATED APPLICATIONS

This application is a continuation-in-part patent application of co-pending U.S. patent application Ser. No. 17/752,985, filed on May 25, 2022, which, in turn, is a continuation-in-part of co-pending U.S. patent application Ser. No. 17/667,081 filed on Feb. 8, 2022, which in turn, is a divisional application of U.S. Pat. No. 11,331,848 issued May 17, 2022 for “3D Printing Bead Configuration” which, in turn, claimed the benefit of U.S. Provisional Patent Application Ser. No. 62/940,419, filed Nov. 26, 2019, for “3D Printing Bead Configuration”, the disclosures of which are hereby incorporated by reference, in total, including the drawings.

### PRIOR ART

As is known to those skilled in the art to the which the present invention pertains the shear strength of additive manufactured parts and in particular, 3D printed parts typically suffer from weak shear and tensile strength in the X-Y plane. To that end, there is disclosed in the above-identified co-pending applications, means and methods for improving the shear strength by alternating the height of the bead in either the bottom layer, solely, or both the top bead layer and lower bead layer, as well as providing infill at the termini of the product or object.

While the inventions disclosed in the aforementioned applications are applicable to those products, molds, etc., which have regular configurations, as opposed to angulated or otherwise irregularly shaped objects, the present invention addresses this issue by providing a bead configuration which addresses the issue of programmed shear or fracture angles.

### BACKGROUND OF THE INVENTION

The present invention pertains to additive manufacturing or 3D printing. More particularly, the present invention concerns both the shear and tensile strength of an additive manufactured product. Even more particularly, the present invention concerns the bead profiles for use in 3D printing to improve the shear strength of a so-manufactured product.

### SUMMARY OF THE INVENTION

The present invention provides means and methods for improving the shear strength of a 3D manufactured object having a fracture angle through an offset bead configuration to alter the fracture angle.

In accordance herewith, in a first embodiment, a first layer of equal width, oval beads is deposited along the X axis where the beads are stepped such that they incrementally increase in height along the X axis.

Subsequent or intermediate layers comprise oval beads which are uniform in height and width and which are deposited thereatop in sequential order beginning from the second layer. Optionally, the top layer may be deposited in the reverse order of the first layer.

In a further aspect hereof, the number of beads may be altered from layer to layer to create gaps at the termini therebetween. The gap can then be filled with strengthening infill.

In either event, the present method minimizes the effect of the fracture angle, especially where the material is deposited using an FDM or SLA process. Regardless of the raster tool path deposited with respect to the X axis of the build tables.

For a more complete understanding reference is made to the following detailed description and the accompanying drawing. In the drawing like reference characters refer to like parts throughout the several views in which:

### BRIEF DESCRIPTION OF THE DRAWINGS

FIG. 1 illustrates a conventional prior art 3D deposited object;

FIG. 2 is a plan view showing a first embodiment hereof shown in the X-Y plane of a 3D deposited manufactured object;

FIG. 3 is a plan view similar to FIG. 2 of a 3D manufactured object according to a further embodiment of the present invention; and

FIG. 4 is a perspective view of the third embodiment hereof.

### DETAILED DESCRIPTION OF THE INVENTION

At the outset, it is to be noted and as is known to the skilled artisan, when employing a 3D additive manufacturing process, the deposition of the layers of material renders the so-obtained object subject to fracture angles. This is especially true when using an FDM or Fused Deposition Method or SLA method of printing.

The present invention as detailed hereinbelow, minimizes or reduces the susceptibility of fracturing by altering the fracture angle of the printed object. This is true regardless of the raster angle and the angle of inclination of the build table.

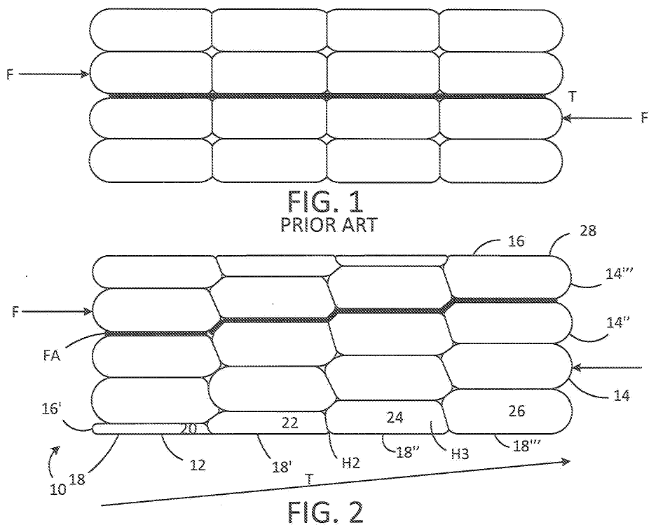

Referring now to the drawing, FIG. 1 illustrates present day prior art fracture angle position or location which is created through the use of traditional FDM or SLA processing. As shown, the fracture angle extends in a plane along the X axis and, where the build table T is substantially horizontal, therefore, the shear strength of the product is seriously affected. As noted, the present invention alters the fracture angle.

Now, and with reference to FIG. 2, there is depicted therein a first embodiment of the present invention, which is generally denoted at 10. As shown, a plurality of bead layers is deposited along the X-axis. The layers include a first or bottom layer 12 and a plurality of intermediate layers denoted at 14,14′ and 14″. A top layer 16 sandwiches the intermediate layers between the top and the bottom layers. It should be noted that although three intermediate layers are shown herein, the present invention is not to be so construed, although there needs to be one intermediate layer.

According to the present invention, the bottom layer 12 comprises a planar layer at a build table angle T, having stepped oval beads 18, 18′ 18,″ etc., each bead being of different heights and of equal width. Thus, as shown, the bottom layer 12 has a first bead 18 of a first height 20, a second bead 18′ of a second height 22, a third bead 18″ of a third height 24 and a fourth bead 18″′ of a fourth height 26.

Each bead in the bottom layer is substantially oval and of equal width, although of different heights. Each bead in each intermediate layer is oval and of equal height and width, as shown. Thus, each intermediate layer has a variable offset bead as highlighted in FIG. 2 to create a stepped layer having an offset fracture angle FA. This is contrasted with the conventional 3D printed object fracture angle as shown in FIG. 1.

Although not essential, preferably, the top layer 16 is deposited in the same manner as the bottom layer, except that it is in the reverse, such that the least height bead 28 has substantially the same height as the first bead 20 deposited in the first layer and therefrom the heights are stepped such that the greatest height bead correlates to the least height bead in the bottom layer. As with each of the beads in the other layers, the beads in the top layer are oval and of equal length, but of varying heights.

It should be noted that in order to achieve the purposes to which the present invention is directed, it is essential that only the bottom layer be stepped, which, as a consequence, causes each additional layer deposited thereover to have the same offset or stepped or fracture angle, which, as a consequence, creates a greater shear strength than with conventional 3D printing.

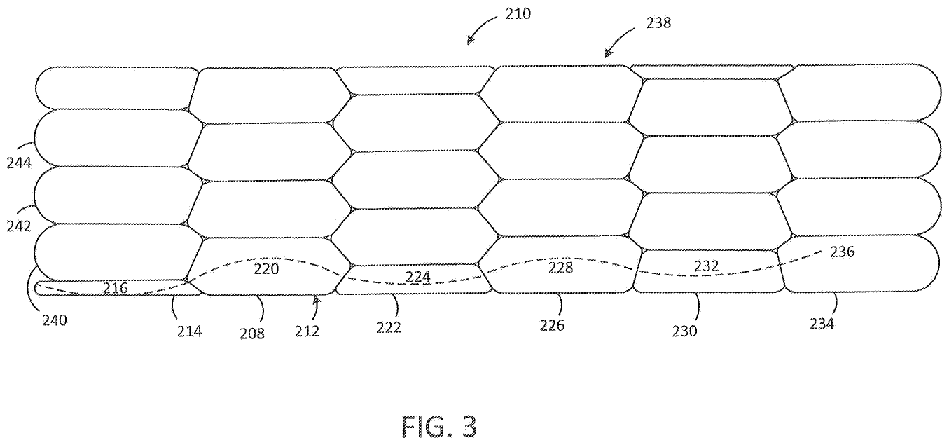

Referring now to FIG. 3, there is depicted therein an alternate embodiment hereof and generally denoted at 210.

According to this embodiment, a first layer of beads is deposited along the X-axis and generally denoted at 212. Here, as shown, the first bead 214 has a first height 216. The adjacent bead along the X-axis 218 has a height 220 which is greater than the height 216. A third bead 222 has a height 224 which is less than the height of the bead 218, but greater than the height 216 of the first bead 214. A fourth bead 226 has a height 228 which is greater than the height 224 in bead 222 and is substantially equal to that of the height 220 in bead 218.

It is also possible to have a fifth bead 230 having a height 232 which is less than that of the height 228 in bead 226, but still greater than that of the height 224 in bead 222. Preferably a sixth bead 234 has a height 236 which is greater than the height 232 and is substantially equal to the heights of 220 and 2228 of beads 218 and 226, respectively. Regardless of the height, each bead is oval and has substantially equal width.

It should be noted that this embodiment is not limited to the six beads but can have any convenient number such that there is created a “sawtooth” array in the bottom layer.

Where the top layer 238 is similarly constructed as that of the first layer, the same configuration is imparted thereto. Thus, the intermediate layers 240, 242 and 244 are stepped in the sawtooth arrangement as that imparted to the top and lower layers.

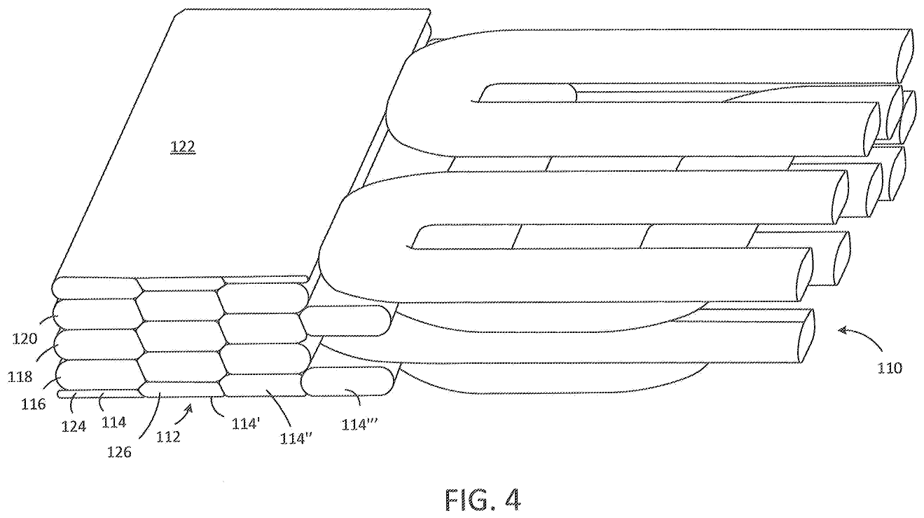

Referring now to FIG. 4, there is depicted therein a further embodiment hereof, generally denoted at 110 hereof. According to this embodiment, a bottom planar bead layer or build table 112 has a series of stepped beads 114, 114′ 114″ etc. deposited along the X axis. Each bead in the layer 112 is oval and of equal width.

A plurality of intermediate layers, three of which are shown at 116, 118′ 120″ are deposited thereatop.

A top layer 122 comprises the reverse order of deposit as that of the beads first layer, as shown.

More particularly, the first bead layer 114 deposited along the X axis is integral with and adjacent to the second bead 114′ of a different height along a vertical axis than that of the first bead 114. Integral with and disposed adjacent to the second bead 114′ is a third bead 114″, which is of a greater height than the second bead along a vertical axis, but of greater height than the second bead. Adjacent thereto is the next bead 114″′ which is of equal height and width to the second bead 114″. This incrementally stepped fracture angle created in the object enables the creation of the object having an improved shear strength, as well as an improved tensile strength when used in conjunction with both regularly configured and irregularly configured objects.

Thus, in depositing the layers, the bottom or first layer has N number of beads; the first intermediate layer has N-1 number of beads; the second intermediate layer has N number of beads, etc. Interstitial gaps 150 are thus created, which are then filled with infill 152 in the same manner as disclosed in the above referred to co-pending application.

Stated alternatively and as shown in the drawing, the first layer of beads along the X axis has a defined number of beads, four of which are shown here. The second or overlying layer of beads deposited thereover in the stepped configuration has at least one less bead deposited along the X axis. The next or subsequent layer of beads overlying the second layer has an equal number of beads as that of the first layer. Thus, a gap is created between the first and third layers. This alternating number of beads along the X axis continues until the top layer is deposited, leaving a gap between it and the first layer therebelow. Strengthening Infill is then deposited into the respective gaps.

Here, the strengthening infill abuts against a wall portion (not shown) of the intermediate portion or segment of the infill main body created by the layers 18, 18′ etc.

The strengthening infill can have any desired configuration such as the U-shape shown herein.

The process hereof generally comprises depositing a first stepped bead layer 18 of the main body infill having increasing or decreasing beads 17 of varying heights. Abutting strengthening infill layers 20, 20′ are deposited and extend laterally inwardly from the mold wall into abutment with an associated layer at least intermittently along the extent thereof, as shown.

This infill 152 deposited into the gaps contributes to not only the shear strength, but tensile strength, as well of the so-produced product.

By having the interstitial infill hereof disposed within the gaps etc. created by the layering, the shear and tensile strength is further improved.

As shown in FIG. 4 the interstitial infill layers are complementary to the abutting layers and thus are alternating therewith as well as the balance of the bead layers.

The strengthening infill can be deposited or printed around the periphery of a mold and extend from the interior wall laterally inwardly before creating the associated first and second width beads having the terminal walls abutting against the infill. Alternatively, the strengthening infill can be printed continuously with the associate intermediate main body layer.

In manufacturing an object according to the principles hereof, both the main body and the interstitial strengthening infill layers are formed from any of the suitable infill materials including, for example, glass fiber-filled carbonate, PEKK, PEEK and ABS, ASA, PLA, PETG, polypropylene, TPU, nylon, polycarbonate, PSU, PPSU, PESU, PEI, as well as metals, ceramics, sand or cement.

The infill can have any desired configuration such as the u-shaped infill shown herein. In depositing the infill, it is created in layers wherein the first layer, as shown, is coaxial with the bottom layer and the second layer is substantially perpendicular to the first interstitial layer and this is repeated in alternating layers, as shown.

The combination of the offset fracture angle and the gap filling infill enhances the shear and tensile strength of any object created therefrom, be it a regular or irregular object.

Although not shown, a computer modeling and additive manufacturing system may be utilized to manufacture the heat exchanger assembly 10. The computer modeling and additive manufacturing system may include a CAD system for designing and generating a computer model of one or more portions of the heat exchanger assembly 10, the CAD system including a processor, a memory, and a user input (e.g., input device and display). The processor is configured to generate the computer model of the desired object according to inputs and data received from a user or other computing device. One or more computer programs are stored in the memory and are executable by the processor to perform the additive manufacturing process to fabricate the object.

The computer modeling and additive manufacturing system may also include an additive manufacturing device (not shown) having a base material (e.g., metal) in a powder, pellet, wire, or other suitable form. The device feeds the base material to a material applicator, which may include a melting device (e.g., laser, heater, or the like) to melt the base material onto a previously constructed layer.

As is known to the skilled artisan, a slicer is software that acts as an intermediary to link the modeling software to the manufacturing software. The slicer software is configured to transform a digital model into instructions for the 3D printing device and may be used throughout one or more steps of the manufacturing process described herein.

It is apparent from the preceding that the present invention provides a new and distinct method for improving the shear strength for an additive manufactured object.

1. An additive manufactured object comprising:
(a) a plurality of layers of bead material having a bottom layer of stepped height beads, each bead being of a different bead height than that of the beads adjacent thereto;
(b) a second layer of beads deposited atop the first layer, each bead in the second layer being of equal height and width and, thus, being stepped when deposited atop the first layer;
(c) at least a third layer deposited atop the second layer and being of equal height, width and oval in shape to that of the second and third layers; and
(d) a fourth layer having reversed height differentiation to that of the first or bottom layer.

2. The object of claim 1 wherein the second layer has one less bead deposited along the X axis as that of the first layer, the third layer having the same number of beads deposited along the X axis as that of the first layer to create a gap between the terminal bead of the first layer and the terminal bead of the third layer and an infill layer deposited in the gap.
